(19) United States
(12) Patent Application Publication
(10) Pub. No.: US 2006/0029139 A1
(43) Pub. Date: Feb. 9, 2006

(54) Data transmission synchronization scheme

(76) Inventors: Detlef Teichner, Koenigsfeld (DE); Christopher Schmidtmann, Villingen=Schwenningen (DE); Hans-Jurgen Nitzpon, Waldbronn (DE)

Correspondence Address: BRINKS HOFER GILSON & LIONE, P.O. BOX 10395, CHICAGO, IL, 60610, US

(21) Appl. No.: 11/188,039

(22) Filed: Jul. 22, 2005

(30) Foreign Application Priority Data
Jul. 22, 2004 (EP) 04017386.6

(51) Int. Cl. H04B 1/66; H04N 7/12; H04N 11/04; H04N 11/02

(52) U.S. Cl. 375/240.28; 375/240.12

(57) ABSTRACT

A data transmission synchronization system provides a method for transmitting a stream of continuous audio and/or video data from a transmitter to a receiver on a communication link where the system determines if synchronization information is present in a data source. If no synchronization information is present, the system generates new synchronization to insert into a transmitted data stream. If synchronization information is present, the system checks the information accuracy and corrects the information if necessary. The system transmits a data stream with inserted synchronization information.

### BACKGROUND OF THE INVENTION

1. Priority Claim

The application claims the benefit of priority from EPO 04017386.6, filed Jul. 22, 2004, which this application incorporates by reference.

2. Technical Field

This invention relates to data transmission schemes for networks. In particular, the invention relates to system for real-time data transmission over a communication link in a vehicle and for re-synchronization at the receiving site.

3. Related Art

Vehicles may include information and entertainment components. Vehicles may use a high-speed network as an infrastructure for managing interacting components in the vehicle. The MOST (Media Oriented Systems Transport) technology standard may be used for high-speed multimedia busses in vehicles. This bus allows a cost efficient communication between all functional blocks of entertainment and information systems such as CD and DVD players, CD changers, cell phones, video systems, in-car PC's and the like. The network bus described by the MOST standard offers a speed of 24.8 Mbits/second which makes it about 100 times faster than control-area network (CAN) busses. CAN busses are typically used in power train applications. The MOST specification defines the hardware interface needed to communicate over the bus, which may be a plastic optical fiber.

The communication on a MOST bus is based on predefined frames including a synchronous area and an asynchronous area. The synchronous and asynchronous areas of a frame may have an arbitrary length where a message to be transmitted may be distributed over a number of frames. The MOST standard also defines an asynchronous packet-transfer mechanism where each packet includes a header portion and a data portion. The MOST bus is a synchronous, circuit-switch network. “Synchronous” means that a single timing master sets the clock for the whole network. All other devices are correspondingly synchronized.

Each MOST frame contains 512 bits and is divided into three separate portions. A first portion having a length of one byte is intended for synchronization administration of the frames. A second portion contains the data to be transmitted, and a last portion with a length of one byte enables a detection of transmission errors. 62 bytes per frame remain for data transmission. This data area may be divided into three different segments intended for transmission of different types of data: synchronized data, asynchronous data, and control and status data.

Although the MOST bus configuration is scalable in that the network can run at any clock frequency that the timing master sets, the bus will only run at that frequency for which the individual MOST bus implementation is provided. Generally, the MOST bus provided in vehicles has a fixed synchronizing scheme with a clock rate of 44.1 kHz. The clock rate is adapted to the transmission of audio data over the communication link. One problem with such MOST bus implementations is that other data to be transmitted between information and entertainment devices within a vehicle may require other clock rates. The individual devices may convert their data stream and clock rate to the bus configuration. Data rate conversion requires additional computational effort for adapting the data rate to the fixed communication link data rate. Also, transmission of a different kind of data may not be accomplished with the same efficiency.

### SUMMARY

This invention provides a data transmission synchronization method for transmitting a stream of continuous audio and/or video data from a transmitter to a receiver on a communication link. The system determines if signal synchronization information, such as a time stamp, is present in the data stream, and either generates new information or corrects existing synchronization information if necessary before inserting the information into a transmitted data stream. The system may be used in a vehicle information and entertainment system to insure reliable transmission of data stream formats such as MPEG video where isynchronous transmission may be used.

The data transmission synchronization system also may check for auxiliary information in the data stream, and generate new auxiliary information or insert the present auxiliary information into a data stream. By processing and/or generating auxiliary information in the data stream, the invention is adaptable to changing data formats available to the system.

The data transmission synchronization system also provides a transmitter with an analyzing unit for determining whether synchronization information is present in the data stream or is accurate. The transmitter may include a time stamp generator to generate new information or correct inaccurate information. The transmitter also may include a multiplexer for inserting the synchronization information into the data to be transmitted to an external system.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 illustrates a transmission system transmitting data on a communication link.

FIG. 2 illustrates a data packet for transmission on the communication link with a fixed synchronization scheme.

FIG. 3 illustrates resynchronization on the receiver side.

FIG. 4 illustrates a transmitter for transmitting data packets on a communication link.

FIG. 5 illustrates a receiver for receiving data.

FIG. 6 illustrates a transmitter.

FIG. 7 illustrates a time stamp generator for use in a transmitter.

FIG. 8 illustrates a transmission scheme generating new time stamps.

FIG. 9 illustrates a transmission scheme employing a re-stamping approach.

FIG. 10 illustrates a transmission scheme for generating new synchronization information including a correction value.

FIG. 11 illustrates transmitting a stream of continuous audio and/or video data from a transmitter to a receiver on a communication link.

FIG. 12 illustrates processing auxiliary information describing the properties of the transmitted data.

### DETAILED DESCRIPTION OF THE PREFERRED EMBODIMENTS

The elements in the Figures interoperate as explained in more detail below. Before setting forth the detail explanation, however, it is noted that all of the discussion below, regardless of the particular implementation being described, is exemplary in nature, rather than limiting. For example, although selected aspects, features, or components of the implementations are depicted as being stored in memories, all or part of systems and methods consistent with the display systems may be stored on, distributed across, or read from other machine-readable media, for example, secondary storage devices such as hard disks, floppy disks, and CD-ROMs; a signal received from a network; or other forms of ROM or RAM either currently known or later developed.

Although specific components of the architecture will be described, methods, systems, and articles of manufacture consistent with the architecture may include additional or different components. For example, a processor may be implemented as a microprocessor, microcontroller, application specific integrated circuit (ASIC), discrete logic, or a combination of other type of circuits or logic. Similarly, memory, may be DRAM, SRAM, Flash, or any other type of memory. Flags, data, databases, tables, and other data structures may be separately stored and managed, may be incorporated into a single memory or database, may be distributed, or may be logically and physically organized in many different ways. Programs may be parts of a single program, separate programs, or distributed across several memories and processors.

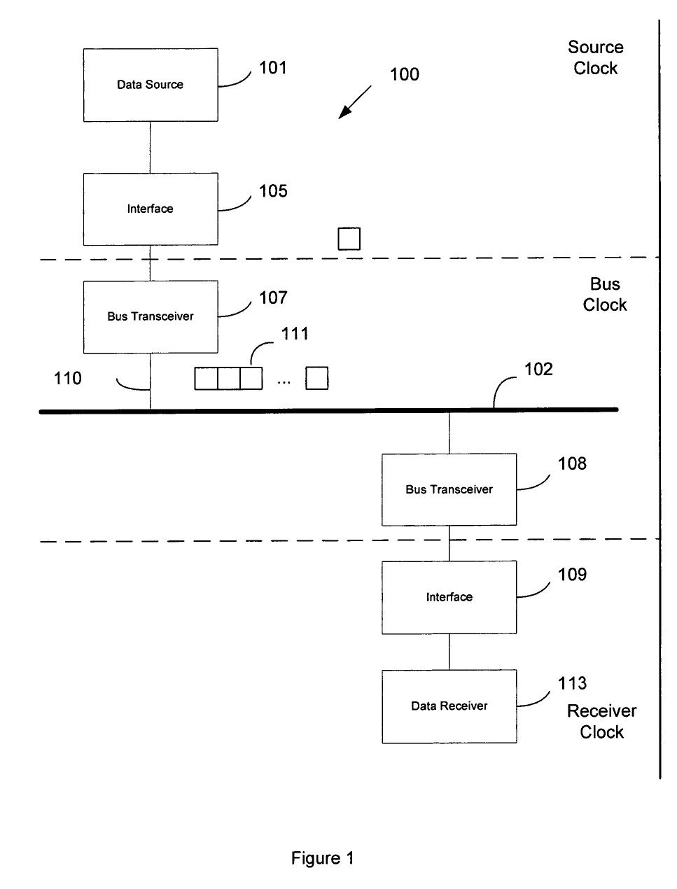

FIG. 1 illustrates a real-time data transmission system 100. The transmission system may be part of an information and entertainment system adapted to transmit video and/or audio data from a data source 101 to a data receiver 103. The data source may provide video and/or audio data from a CD, a DVD, a (vehicle) radio, a cell phone, a vehicle navigation system, an Internet access device, or other devices. The receiver 103 may be adapted to reproduce the received data visually or aurally, such as on a visual display or by means of loudspeakers. Examples of displays include LCD screens, vehicle information graphic displays, cell phone displays, PDA screens, television, portable DVD players, or laptop displays.

The data source 101 may supply the data to be transmitted to an interface 105, which may configure the data for transmission over the communication link 102. The data processed by interface 105 may be supplied to bus transceiver 107, which inserts the data on the communication link 102. The interface 105 and the bus transceiver 107 are not required to be separate devices. The interface 105 and the bus transceiver 107 may be integrated as one device such as a vehicle interface unit or other interface unit. The communication link 102 may be implemented through a MOST network connecting the different devices connected sequentially.

A receiving unit also may include a receiver bus transceiver 108 to establish connection to the communication link 102. The received data may be supplied to an interface 109 to reconstruct the continuous data stream sent from a transmitter. Again, the interface 105 and the receiver bus transceiver 108 may be incorporated into a single unit as already described in connection with an interface 105 and a transmitter bus transceiver 107 of the transmitter. The reconstructed data may then be supplied to the data receiver 113 for further processing.

The transmission system may include an inner synchronization scheme of the MOST network and an outer synchronization scheme for synchronizing the receiver's clock to the source clock. The data to be transmitted may be transferred over the communication link 102 based on the fixed synchronization scheme between the transmitter bus transceiver 107 and the receiver bus transceiver 108. A resynchronization of the transmitted data may be achieved in the receiver interface 109 based on time stamps inserted into the transmitted stream of data on the transmission side.

The transmitter bus transceiver 107 may first divide the continuous stream of data 110 from the transmitting site into a plurality of data packets 111. These data packets may be inserted on the communication link 102. In a receiver interface 109, the data packets 111 may be received from the communication link 102 and reconstructed in order to output a continuous stream of data 110 that corresponds to the original stream of data. The application facilitates the data transmission in the form of data packets 111 by a control scheme, which enables an accurate reconstruction of the original continuous data stream 110 and re-synchronization with the transmitter's clock.

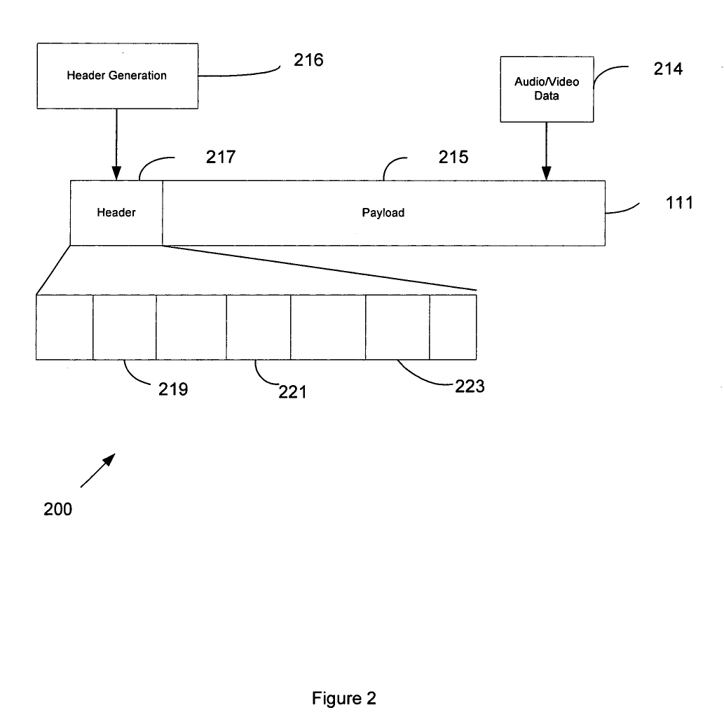

FIG. 2 illustrates the configuration of data packets 111. Each data packet 111 may include a header portion 217 and a data or payload portion 215. The payload portion 215 may contain only audio and/or video data to be reproduced by a receiver 113. The header portion 217 may contain control information needed for the multimedia network control and in particular for reliable packet transmission. Examples of control information include frame and packet routing information, quality of service (QOS) guarantees for the packets, and priority status of packets transmitted. The header portion 217 may include a number of portions 219, 221, and 223 including auxiliary information relating to the data of the payload area 215. These data segments may be separated from the received continuous stream of data 110 and inserted into the header portion 217 by the header generation unit 216. At the receiver side, these portions 219, 221, and 223, which are needed for the reproduction of the audio/video data 214, may again be inserted into the reconstructed data stream or are used for its reconstruction.

The interfaces 105 and 109 on the receiver and transmitter side respectively may be configured to process a number of different user data formats. Examples include video data encoded with MPEG, JPEG, WMA, WMV, MOV, or audio data encoded with PCM, MP3, WMA, AC3, or other formats. Based on the predefined positions or indications for user data and auxiliary data portions 219, 221, and 223 within the different types of data streams, a reliable separation of audio/video data 214 and its auxiliary data portions 219, 221, and 223 may be accomplished.

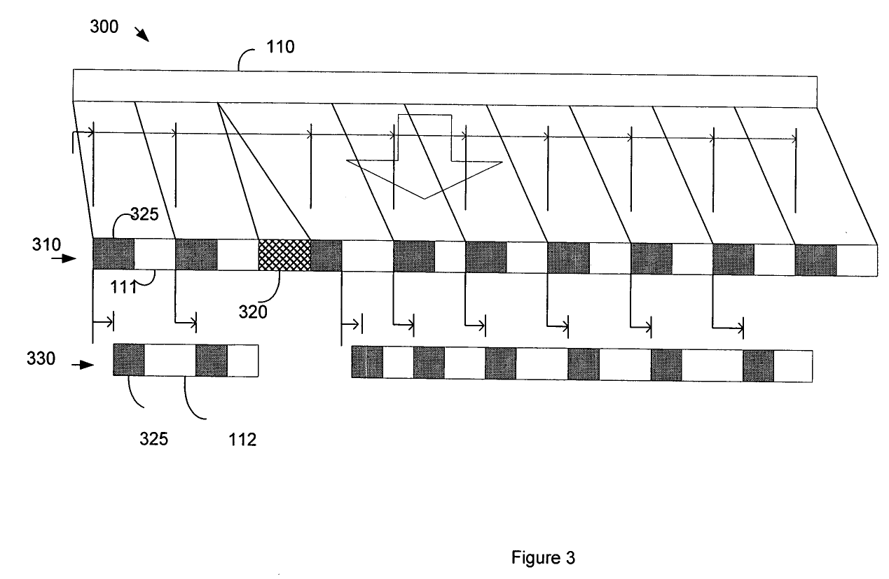

FIG. 3 illustrates a multimedia system. The original stream of data 110 may be divided into a plurality of data packets 111. Each of the data packets 111 may include synchronization information 325 indicating the individual position of a data packet 111 within the transmitted stream of data 110. The synchronization information 325, for example time stamps, may continuously transmit the transmitter's current clock to the receiving node. Any kind of appropriate pointers, for example a count value, time data, or any other kind of data, may be used. The data packets 111 may be inserted on the communication link 102 as a stream of data 110 and transmitted to the respective receiver, which is indicated within the control information of each data packet. The transmission of data packets may require “stuffing” packets 320 to adapt the communication link's 102 data rate to that required for the transmission of the continuous stream of data 110.

The received data packets 312 of a particular receiver may be processed to form a data stream 330 to be output to a reproducing device. Examples of reproducing devices include video displays, audio devices, vehicle information and entertainment devices, and other multimedia devices. The extracted synchronization information 325 is employed to reconstruct the transmitter's clock at the receiving side. The original stream of data 110 may be reliably reconstructed and synchronized.

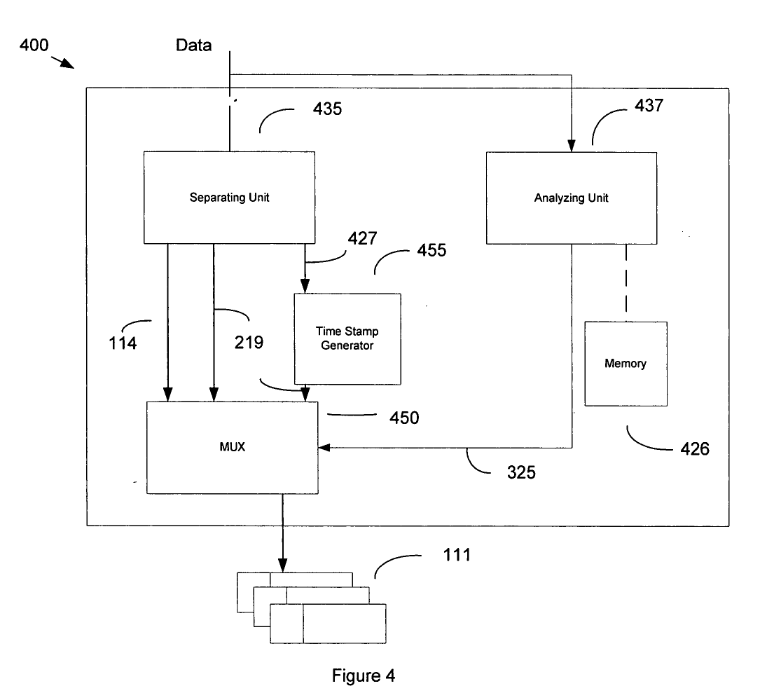

FIG. 4 illustrates an interface 105 for processing the continuous data stream 110 for insertion on the communication link 102. The data to be transmitted are not restricted to a particular data format. Different kinds of data, such as compressed or uncompressed data, may be transmitted in an efficient manner. The data stream 110 may, for example, include PCM data having its own PCM clock. The same interface 105 also may automatically adapt to compressed data formats already including their own synchronization information 325. Examples of data formats include LZW compressed data, run-time encoding, and other compression schemes.

The communications link 102 may first supply the received stream of continuous data 110 to a separating unit 435. The separating unit 435 may analyze the individual data and may identify the kind of data to be transmitted. The received stream of continuous audio and/or video data 110 may first be supplied to the separating unit 435 and an analyzing unit 437. The analyzing unit 437 may analyze the received data 110 and may identify the kind of data to be transmitted. In particular, the data format may be determined. The data format may include at least one of the following: the type of compression if present, the type of packeting (for example, program stream, transport stream, no packeting), and the data rate. Another data format includes the MPEG international standard, where reference time stamps may be retrieved from a transport stream syntax, a program stream syntax or packetized elementary stream syntax of the continuous stream of audio and/or video data 214.

Depending on the identification result, the appropriate approach for providing synchronization information for the new synchronization scheme may be selected. Specifically, the interface 107 may determine whether or not available synchronization information 325 from the data stream 110 may be retrieved and appropriately incorporated into the data transmitted on the communication link 102. The determination procedure may be performed based on data format properties that may be stored in advance in a memory 426 connected to the analyzing unit 437. The memory 426 may store appropriate processing information, such as the data stream format, packet timing and rate information, compression scheme, and other data information.

The memory 426 may be a solid state memory such as volatile or non-volatile memory, flash, or hard disk drive. The memory 426 may store the analysis information in the form of look-up-table data. According to the format and/or synchronization details of the data stream 110, processing information indicates how to process the data by transmitter 104. In particular, the look-up-table may indicate the conditions for which particular kinds of synchronization information 325 may be generated. The separate memory 426 may supply its content to the analyzing unit 437. The memory 426 also may integrate with the analyzing unit 435 to form a single unit. The memory 426 allows update of new types of data, such as new compression standard or packet formats. The analyzing unit 437 functionality may be enhanced or reconfigured based on the memory 426 contents.

The separating unit 435 may provide audio and/or video data 214 which may or may not contain any auxiliary information 219, 221, and 223. The auxiliary information 219, 221, and 223 may be output separately. When the received data 110 does not include any auxiliary information 219, 221, and 223, the analyzing unit 437 may analyze the received data stream 110 to extract particular parameters. The analyzing unit 437 may analyze the received data 110 based on audio and/or video formats that are configured in the system in advance from the look-up-table data stored in the memory 426. Depending on the detected format of the data, the analyzing unit 437 may separate the audio and/or video sample values from the auxiliary information 219, 221, and 223, and determine the type of synchronization information 325 to be generated.

The memory 426 may be configured in advance to enable analyzing unit 435 to analyze and identify any of the relevant data formats such as transmission formats like MPEG (PS—Program Stream, TS—Transport Stream), interface formats like S/PDIF (Sony/Phillips Digital Interface—a standard audio transfer format) or 12S, and data type formats like PCM, MP3, WMA, AC3, AAC, DTS or MLP.

The separating unit 435 may extract existing time stamps or any kind of clock reference information—if available—from the received data stream 110 for further use in the multimedia system. The extraction operation is automatically initiated upon detection of a data format including such synchronization information. The received data 110 also may be converted into a particular data format different from the received data format before transmission. The received data format will then be transmitted as auxiliary information 219, 221, and 223 in the header portion 217 of a data packet 111 in order to enable reconstruction and/or further processing of the received data format on the receiver side. Although the data transmission is performed based on the fixed clock rate of the communication link 102, the clock rate for re-synchronization of the receiver 400 to the transmitter 500 is independent of the transmission clock rate. In particular, the resynchronization clock rate may be higher or even a fractional multiple of the communication link clock rate. This is accomplished by using an independent synchronization scheme over the fixed synchronization of the communication link 102.

No synchronization of the transmitter 500 and receiver 400 to the clock of the communication link 102 is required, as the receiver 400 will automatically synchronize to the transmitter's clock—independently of the clock on the communication link 102. Thus, an isynchronous transmission, i.e., an asynchronous transmission over a synchronous communication link of real time data, may be achieved.

A multiplexer 450 may combine the audio and/or video data 214 with the header information 217 containing the auxiliary information 219, 221, and 223, time stamps 425 and additional control information needed for the multimedia network control (not shown). The time stamps 425 are received from a time stamp generator 455. The generator 455 provides clock reference information to enable a resynchronization of the transmitted data on the receiver side in accordance with control information received from analyzing unit 437. The multiplexer 450 may receive the separate information from the respective sources and may combine the separate information to provide the individual data packets 111 for transmission on communication link 102.

The time stamp generator 426 may produce time data or count values as reference clock information 427. These data may be generated based on an internal clock or by a clock received from an external device. The reference clock information 427, in particular the time stamps 425, which are extracted from the continuous input data stream 110, may be used. The continuous stream of audio and/or video data 214 may bein a transport stream format in accordance with the MPEG international standard and the existing time stamps 425 may be the program clock reference time stamps of the transport stream, program stream, or packetized elementary stream.

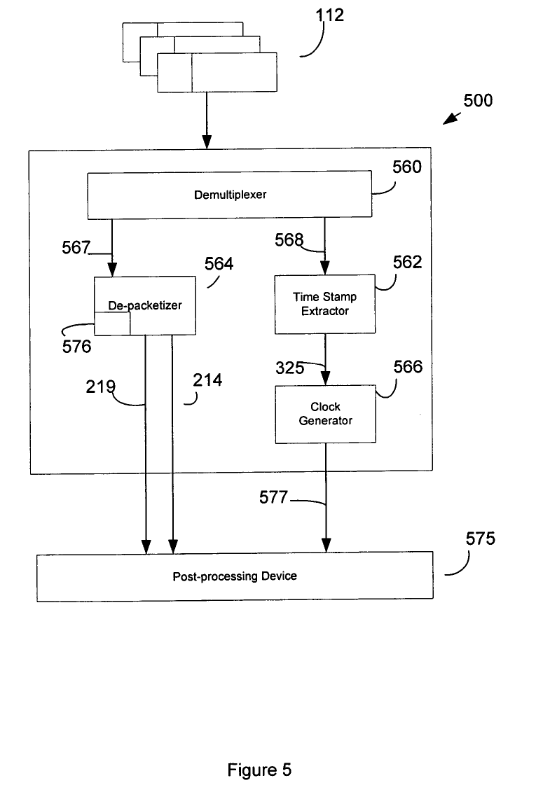

FIG. 5 illustrates a receiving interface 109. The interface 109 may include a demultiplexer 560, a time stamp extractor 562, a depacketizer 564, and a clock generator 566. The data packets 112 received from the communication link 102 may be supplied to a demulitiplexer 560. The demultiplexer 560 may separate the different kinds of packet information 567 and 568 from the data packets 112 and may supply the packet information 567 and 568 separately. Specifically, the demultiplexer 560 may extract audio and/or video data 214 in the packet information 567 (including auxiliary information) and time stamps 425 in the packet information 568. The depacketizer 564 may generate a continuous stream of audio and/or video data 214 from the received user data packets 112 and may further extract the auxiliary information 219 from the received data packets 112.

The time stamp extractor 562 may extract the synchronization information 325 from the received data packets 112 and may apply the extracted synchronization information 325 to the clock generator 566. The clock generator 566 may generate a new clock 577 based on the received synchronization information 325. The audio and/or video data 570, the auxiliary information 571 and the new clock 577 may be applied to a post processing device 575 to further process the received data. The post-processing device 575 may, for instance, decode the received audio and/or video data 214 for reproduction purposes. For example, the post-processing device 575 may process the data 214 for multichannel sound output, video sizing or spatial and/or temporal effects, and other audio and/or video processing effects. The post-processing (in particular a decoding processing) may be simplified by the auxiliary data 219, 221, and 223. Based on the data properties included in the auxiliary data 219, 221, and 223, the system may avoid time consuming detection and processing capacity. If the user data have been converted to a common data format, the extracted data 512 may be reconverted in a data converter 576 which may replace or may be included in the de-packetizer 564. The extracted data 214 may be reconverted to the original data format 567 based on format information transmitted within the auxiliary data 219.

Processing capacity needed for analyzing the data stream and identifying the particular details thereof may be shifted from the receiving side to the transmitting side. This is advantageous when transmitting data from a small number of transmitters to a large number of receivers. The total amount of processing power needed within such an information and entertainment system may be reduced without adversely affecting the processing results.

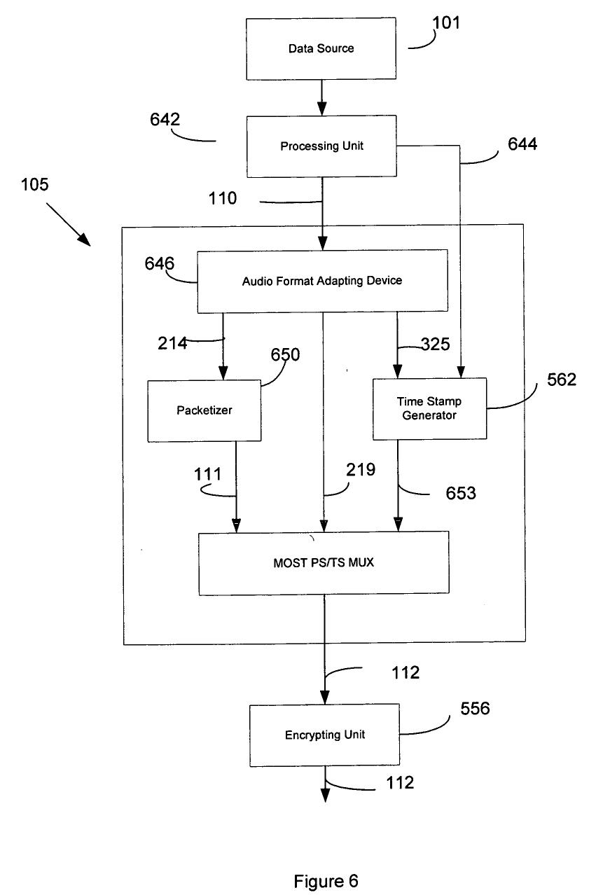

FIG. 6 illustrates a transmitting interface 105, which receives data from a data source 101. The interface 105 may include an audio format adapting device (AFA) 646 (which corresponds to the separating unit 435 and the analyzing unit 437 of FIG. 4), and a processing unit 642. The interface also may include a packetizer 650 and a MOST multiplexer 654. The packetizer 650 and the MOST multiplexer 654 may be integrated into a single processing unit. The time stamp generator 652 also may be integrated with the MOST mulitplexer 654.

The reproduced/received data 101 may be supplied to the processing unit 642. The processing unit 642 may be configured to process the received data 101 to transmit the processed data 643 to a remote device. The data source 101 may be from a data storage device like a CD or a DVD, received from a data network or broadcasting network like the Internet or radio/tv network, or from a wireless connection such as a WiFi, Bluetooth, or infrared connection to a data stream. The processing unit 642 may be a CD or DVD player, a DVB receiver, a car navigation system, a cell phone, car radio, vehicle information and entertainment units, or other devices. The processed data 110 may generally be in compliance with a standard data format such as MPEG (PS—Program Stream, TS—Transport Stream), interface formats like S/PDIF (Sony/Phillips Digital Interface—a standard audio transfer format) or 12S, and data type formats like PCM, MP3, WMA, AC3, AAC, DTS or MLP.

The processed data 110 are output from the processing unit 642 to the transmitting interface 105, where the transmitting interface 105 transmits the transmitted data 112 to a remote device on the communication link 102. The data 110 to be transmitted are first supplied to the audio format adapting device (AFA) 646 which corresponds to the separating unit 435 and the analyzing unit 437 of FIG. 4. The AFA unit 646 may analyze the received data stream 110 to determine the data format. The extracted audio and/or video data 214 may be forwarded to a packetizer 650. The additional auxiliary information 219 included in the received data 110 may be separated from the received data 110 based on the detected data format and forwarded to the MOST multiplexer 654.

The AFA unit 646 determines the data transmission format from the received data stream 643. Depending on the detection result, the AFA unit 646 may either: extract synchronization information 325 from the received data stream 101 for use as reference clock information or may generate reference clock information. The synchronization information 325 extracted from the received data stream 101 may be inserted into the transmitted data packets. In addition, an external clock reference signal 644 may be applied to the time stamp generator 652 for generating or adapting the synchronization information 325. The stream of audio or video data 214 may be supplied to the packetizer 650 for dividing the continuous stream of data into data packets of a predefined size. The resulting data packets may be supplied to the MOST multiplexer 654.

The multiplexer 654 may add the header portion to the data packets 111 received from the packetizer 650. The data portion may include control information mandatory for the packet handling on communication link 102, auxiliary information 219, 221, and 223 extracted from the original data stream 101 and reference clock information 653. The data packets 112 may be output to the communication link 102, such as a MOST network. An encryption unit 656 may process the data packets 112 before inserting the data packets 655 on the communication link 102. Encrypting the data packets prevents unauthorized access to the data transmitted over the communication link 102. The encryption unit 656 may be incorporated into the transmitter interface 105, allowing the encryption unit 656 to encrypt the data output from the packetizer 650. The data also may be decrypted on the receiving side 109 and 113. The decrypting unit may be provided ahead of the receiver interface 109 or may integrate with the receiver interface 109.

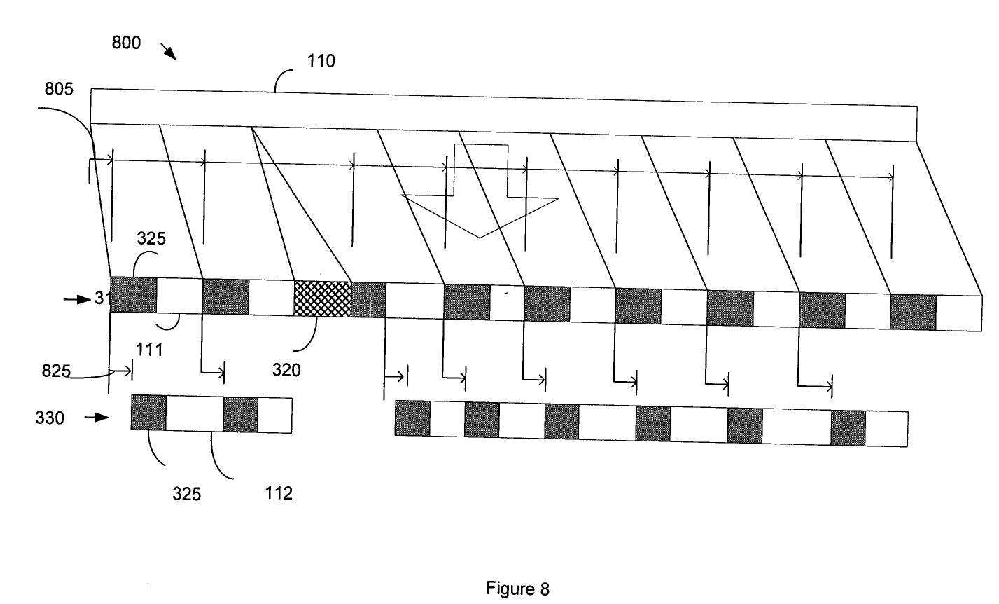

FIG. 8 illustrates generating and employing synchronization information 325 when transmitting predefined data formats that do not have reference clock information. For example, the elementary stream or packetized elementary stream of the MPEG standard does not include reference clock information. The elementary stream is the most basic component of an MPEG bit stream. Each elementary stream contains a single type of (usually compressed) data. Each elementary steam is formed into a stream of packetized elementary stream packets. A packetized elementary stream packet may have fixed or variable size blocks. Such data streams not having synchronization information 325 may be provided over interfaces like 12S and S/PDIF.

The synchronization information 325 may be in the form of time stamps 425 inserted into the data packet 111, for example into the header portion 217. The transfer rate of the communication link 102 may exceed the data rate required for the continuous stream of data 110 when segmenting the data into packets based on the received continuous stream of data 110. The transmission of data packets may require “stuffing” packets 320 to adapt the communication link's 102 data rate to that required for the transmission of the continuous stream of data 110.

The time stamp values for each of the time stamps 425 may be calculated based on the clock signal of the continuous stream of data 110. For instance, an audio data stream may be based on a system clock of 27 MHz. Based on this clock signal, a time stamp counter may calculate time stamp values to be inserted into the stream of data 310 to be transmitted.

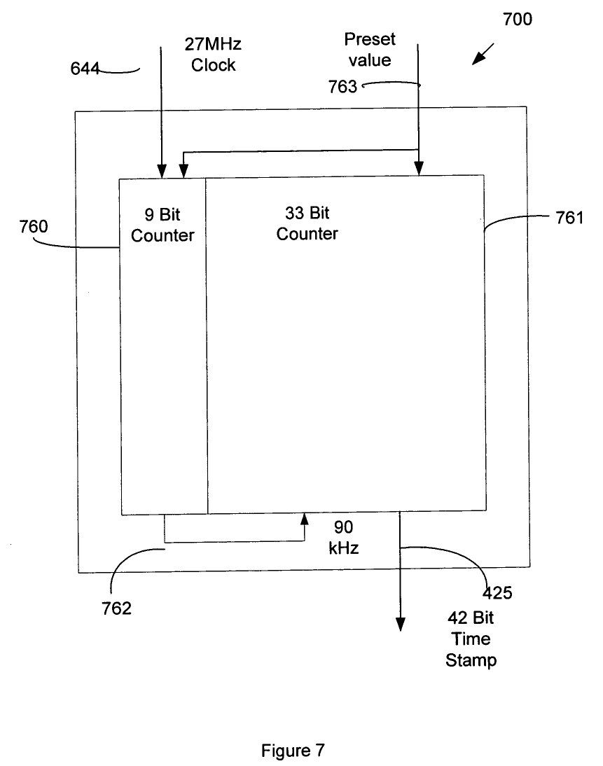

FIG. 7 illustrates a time stamp generator 426 for generating a 42 bit time stamp value. The time stamp generator 426 may include a cascaded counter configuration consisting of a 9 bit counter 760 and a 33 bit counter 761. The first counter 760, the 9 bit counter, up-counts a count value in accordance with the supplied clock signal 744, for instance the 27 MHz clock of an audio data stream. Each time the 9 bit counter 760 arrives at a predetermined count value, a carry signal 762 may issue and apply to the second 33 bit counter 761. The predefined count value may be set to 300 for producing a carry over 762 to the second counter 761. The second counter 761 may have a frequency of 90 kHz when receiving an input clock frequency of 27 MHz. Each time the first counter 761 reaches the predefined count value 763, the first counter 760 will reset. The count results of the first counter 760 and of the second counter 761 may combine to form a 42 bit time stamp value 425 for insertion into the data packets 111.

The transmitter 400 as well as the receiver 500 may require a constant processing delay 805 and 825 when processing the continuous stream of data 110. While the generation of time stamp values 425 for the data stream 110 may take into account the individual packet position, such as offsets resulting from stuffing packets 820, the constant processing delay of the receiver may enable an extraction of the received data packet 112, each having a correct position for its time stamp value 425.

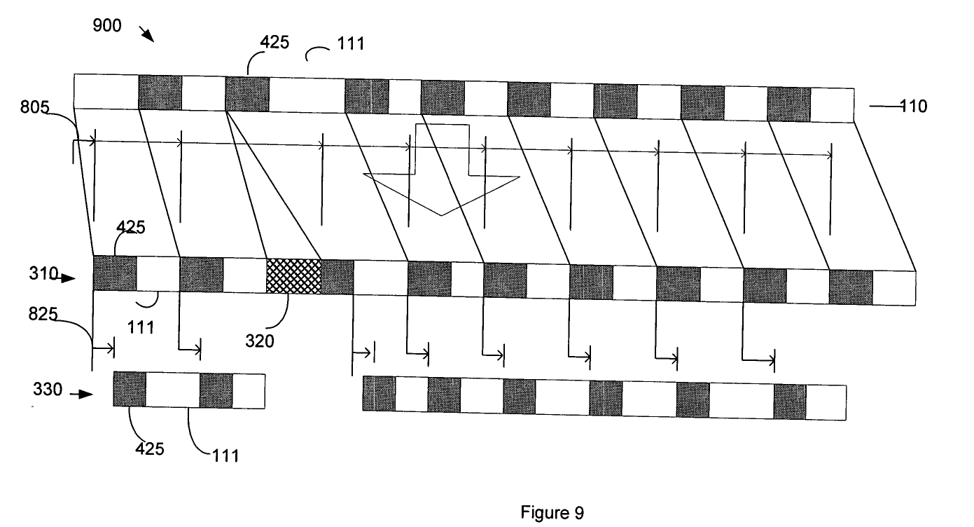

FIG. 9 illustrates processing a stream of continuous audio and/or video data 110 having time stamps 425 included. Such streams of data may, for instance, be provided from optical disk players such as DVD or CD players providing a data stream with time stamps within the program data stream. The receiver 400 may subject the time stamps 425 to a “restamping” to configure the time stamp value to the packet position 111, if the receiver 400 detects a data format with time stamps 425 already included. The time stamp values 425 may be extracted from the stream of data 110 and corrected in accordance with the insertion position of a data packet 111.

To correct the available time stamp values 425 into the corrected time stamp values 920, the time stamp generator 426 may initiate a counting procedure starting from a present value 763. The preset value 763 may correspond to the obtained time stamp 425 from the continuous stream of data 110. The count value is incremented according to the system clock 644 received together with the continuous stream of data 110. The existing time stamp values 425 may be corrected with the insertion position within the stream of data 110 transmitted on communication link 102. The constant preprocessing delays 805 and 825 may enable the reconstruction of the output stream 330 while each packet 111 has a position corresponding to its time stamp value 425.

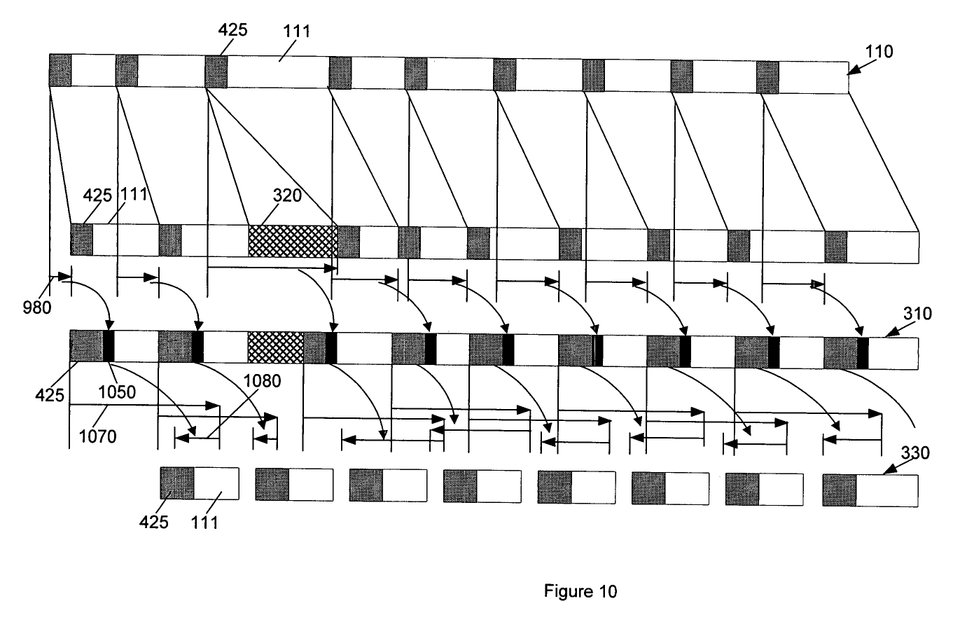

FIG. 10 illustrates time stamp generation without an additional system clock reference 644. For instance, DVB signals may provide time stamp values 425 but may not be accompanied by a system clock reference. In this example, the existing time stamp values 425 are not amended for transmission to a receiver 400. Correction values 1050 may be generated and inserted as supplementary information for the existing synchronization information 325 to adapt the synchronization information 325 of each data packet 111 within the stream of transmitted data 110. The time stamp generator 426 may determine the offset values 1080 based on the transmitter's clock. The synchronization information 325 may correct the offset of each data packet 111 with respect to time compared to its original position. The correction value 1050 may determine the offset value 1080 and the offset value 1080 may be inserted into the data packet 111, such as into the data packet header portion.

The receiver 400 first may determine the position of each received data packet 111 and may adjust the received data packet 111 based on the correction value 1050. The receiver may apply a constant delay 1070 (preferably a constant memory delay) to each received data packet and may extract the individual data packet 111 based on an individual offset value 1080 obtained from the correction value 1050. The constant delay value 1070 for buffering all received data packets may be a constant value exceeding the maximum time shift 1080. A synchronization may be achieved, even if no external clock signal for the data to be transmitted is available. By employing the synchronization scheme of the application, audio and video data 110 may be transmitted on the same communication link 102 without any costly hardware for adapting the data rate of the continuous stream of data 110 to the communication link 102 clock.

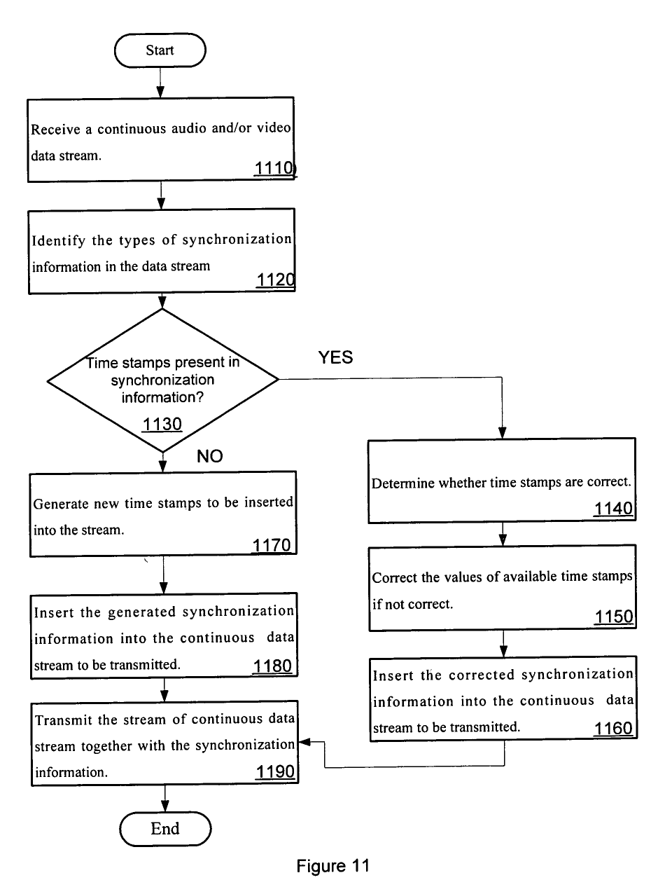

FIG. 11 illustrates transmitting a stream of continuous audio and/or video data from a transmitter to a receiver on a communication link 1100. The communication link 102 may transmit data in synchronization with a first clock signal 744. The receiver 400 analyzes the stream of continuous audio and/or video data 110 and determines the type of synchronization information available (act 1110). The data 110 may be received from an external source such as disc or other storage media, wired, or wireless medium. Examples of external sources include CD, DVD, hard disk, flash and other solid state memory, coaxial and RCA connected sources such as radio and/or television, and Internet, WiFi, Bluetooth, and IR signals. An analyzing unit 437 may analyze the stream of data 110 to identify the types of synchronization information in the data 110, if present (act 1120). The analyzing unit 437 may use information stored in look-up table The use of a look-up table reduces the processing time needed for the analysis step. The look-up table may be stored in a memory 426 for convenient access. The receiver 400 may also store the synchronization information in a memory, such as a non-volatile re-writable memory. The receiver 400 may determine whether the stream 110 contains time stamps 425 (act 1130). If the receiver 400 determines that the stream 110 contains time stamps 425, the receiver 400 may determine if the time stamps are correct (act 1140). The time stamp generator 426 may correct the values of available time stamps 425 obtained from the stream of continuous audio and/or video data 110 if the time stamps 425 are not correct (act 1150). The transmitter transceiver interface 107 may then insert the corrected time stamps 425 into the continuous audio and/or video data stream 110 to be transmitted (act 1160). A time stamp generator 426 may generate new time stamps 425 to be inserted into the stream of continuous audio and/or video data 110 if the time stamp generator determines that the stream of continuous audio and/or video data 110 does not contain time stamps 425 (act 1170). The transmitter transceiver interface 107 may insert the generated time stamps 425 into the continuous audio and/or video data stream 110 to be transmitted (act 1180). The transmitter transceiver interface 107 may then transmit the continuous audio and/or video data stream 110 together with the synchronization information 325 (act 1190) to an external output, such as a video display, entertainment unit, loudspeakers, or other post-processing device.

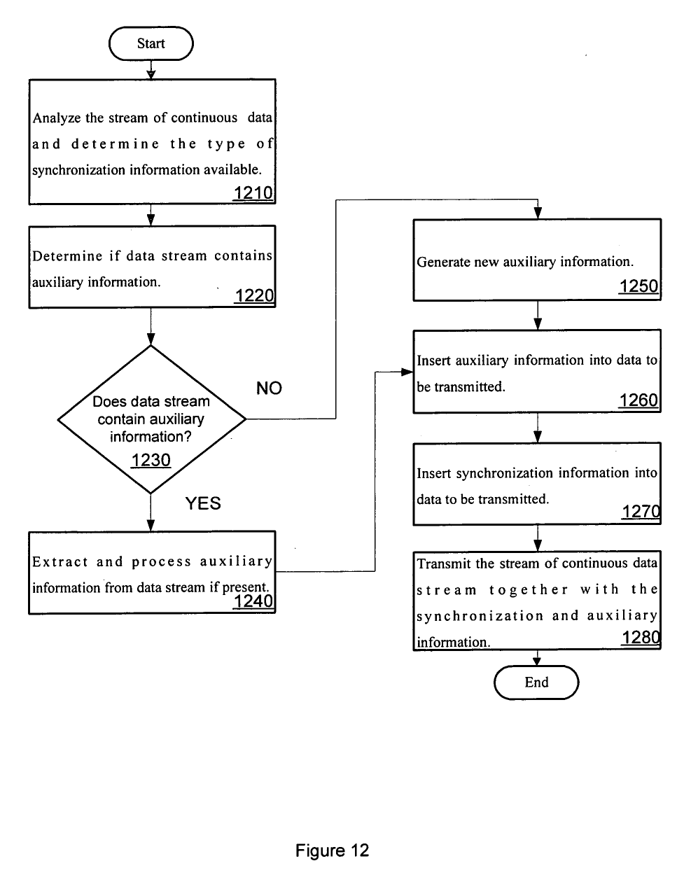

FIG. 12 illustrates processing auxiliary information describing the properties of the transmitted data 1200. The communication link 102 may transmit data in synchronization with a first clock signal 744. The receiver 400 analyzes the stream of continuous audio and/or video data 110 and determines the type of synchronization information 325 available, which may include auxiliary information (act 1210). Examples of auxiliary information include frame protocols, transport protocol information, types of frames, and frame processing parameters. The receiver 400 also may determine whether or not the received continuous stream of audio and/or video data 110 includes auxiliary information 219, 221, 223 describing properties of the data to be transmitted (act 1220). The receiver 400 may extract and process the auxiliary information 219, 221, 223 from the continuous stream of audio and/or video data 110 if the receiver 400 determines that auxiliary information 219, 221, 223 is included in the continuous stream of audio and/or video data 110 (act 1240). The transmitter transceiver interface 107 may insert the auxiliary information 219, 221, and 223 into data to be transmitted (act 1260). The receiver 400 may analyze the continuous stream of data 110 based on the data packet 111 and header 217 information and may generate the auxiliary information 219, 221, 223 based on the results if the receiver 400 determines that auxiliary information 219, 221, 223 is not included in the continuous stream of audio and/or video data 110 (act 1250). The transmitter transceiver interface 107 may insert the auxiliary information 219, 221, 223 into the data 111 to be transmitted (act 1260). The transmitter 500 may insert synchronization information 325 into the stream of continuous audio and/or video data 110 to be transmitted (act 1270). The synchronization information 325 may be extracted from the data stream 110 or generated if no time stamps 425 are present in the data stream 110, according to the method 1100 illustrated in FIG. 11. The transmitter 500 may transmit the stream of continuous audio and/or video data together with the synchronization information 325 and the auxiliary information 219, 221, 223 (act 1280) to an external output, such as a video display, entertainment unit, loudspeakers, or other post-processing device.

The application avoids a synchronized transmission and enables the use of a packetized transmission mechanism for a synchronous transmission of data, in particular for real time applications of audio and/or video data. Available synchronization information within the data is identified and reused for efficient transmission and resynchronization purposes to adapt the synchronization scheme to the data format. A transparent and efficient transmission of data may be achieved over a packet-based transmission network.

The sequence diagrams of FIGS. 11 and 12 may be encoded in a signal bearing medium, a computer readable medium such as a memory, programmed within a device such as one or more integrated circuits, or processed by a controller or a computer. If the methods are performed by software, the software may reside in a memory resident to or interfaced to the receiver 400, the transmitter 500, a communication interface, or any other type of non-volatile or volatile memory interfaced or resident to the data transmission system 100. The memory may include an ordered listing of executable instructions for implementing logical functions. A logical function may be implemented through digital circuitry, through source code, through analog circuitry, or through an analog source such through an analog electrical, audio, or video signal. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that also may execute instructions.

A “computer-readable medium,” “machine-readable medium,” “propagated-signal” medium, and/or “signal-bearing medium” may include any means that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A machine-readable medium also may include a tangible medium upon which software is printed, as the software may be electronically stored as an image or in another format (e.g., through an optical scan), then compiled, and/or interpreted or otherwise processed. The processed medium may then be stored in a computer and/or machine memory.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A method for transmitting a stream of continuous audio and/or video data from a transmitter to a receiver on a communication link, where the communication link transmits data in synchronization with a first clock signal, comprising
determining whether the data stream contains synchronization information;
if present, determining the accuracy of the synchronization information;
generating new synchronization information if no synchronization information is present in the data stream, or generating corrected synchronization information if present synchronization information present in the data stream is inaccurate;
inserting the generated new or corrected synchronization information into the data stream; and
transmitting the data stream with the new or corrected synchronization information to the receiver.

2. The method of claim 1, where determining whether the data stream contains synchronization information comprises analyzing additional information provided separately from the data stream.

3. The method of claim 2, where the additional information is stored in a look-up-table.

4. The method of claim 3, where the additional information is stored in a memory.

5. The method of claim 4, where the synchronization information comprises one or more time stamps.

6. The method of claim 5, where the analyzing step comprises identifying a data format of the data stream.

7. The method of claim 6, where the data stream comprises a data stream formatted in accordance with the MPEG international standard and where the time stamps are one or more MPEG reference time stamps.

8. The method of claim 7, where the MPEG reference time stamps are retrieved from a transport stream syntax, a program stream syntax or a packetized elementary stream syntax contained in the continuous stream of audio and/or video data.

9. The method of claim 5, further comprising:
determining whether the data stream contains auxiliary information describing properties of the data stream;
if present, extracting the auxiliary information from the continuous stream of audio and/or video data;
analyzing the data stream and generating the auxiliary information if no auxiliary information is present in the data stream; and
inserting the auxiliary information into the data stream.

10. The method of claim 9, where determining whether the data stream contains auxiliary information comprises analyzing additional information provided separately from the data stream.

11. The method of claim 10, where the additional information is stored in a look-up-table.

12. The method of claim 11, where the additional information is stored in a memory.

13. The method of claim 12, where the auxiliary information comprises information associated with a post processing device.

14. The method of claim 13, where the auxiliary information identifies encoding parameters of the data stream.

15. The method of claim 14, further comprising forming data packets from the data stream for transmission on the communication link.

16. The method of claim 15, where each of the data packets comprises a payload portion for receiving a data portion of the data stream and a header portion for receiving control information of the data stream, where the synchronization information is inserted into the header portion.

17. The method of 5, where the communication link comprises a vehicle multimedia bus.

18. The method of claim 17, where the vehicle multimedia bus is configured in accordance with the international Media Oriented Systems Transport (MOST) standard.

19. A transmitter for transmitting a stream of continuous audio and/or video data to a receiver on a communication link where the communication link transmits data in synchronization with a first clock signal, comprising:
an analyzing unit for analyzing the data stream and determining whether synchronization information is available in the data stream and, if available, whether the synchronization information is accurate,
a time stamp generator for generating new or corrected synchronization information to replace absent or inaccurate synchronization information, and
a multiplexer unit for inserting the new or corrected synchronization information into the data stream and for transmitting the data stream with the inserted synchronization information to the receiver.

20. A transmitter of claim 19, where the analyzing unit analyzes the data stream based on additional information provided separately from the data stream.

21. A transmitter of claim 19, where the synchronization information is one or more available time stamps.

22. A transmitter of claim 21, where the time stamp generator maintains each available time stamp and generates a correction value for each of the available time stamps.

23. A transmitter of claim 22, where the analyzing unit determines whether a clock of the data stream is available, and where the time stamp generator generates the correction values if there is no clock available in the data stream.

24. A transmitter of claim 23, where the analyzing unit identifies a data format of the data stream.

25. A transmitter of claim 24, where the data stream comprises a data stream formatted in accordance with the MPEG international standard and where the time stamps are MPEG reference time stamps.

26. A transmitter of claim 19, where the analyzing unit:
determines whether or not the data stream contains auxiliary information describing properties of the data;
if present, obtains and analyzes the auxiliary information from the data stream;
generates the auxiliary information if no auxiliary information is present in the data stream; and
supplies the auxiliary information to the multiplexer for insertion into the data stream.

27. A transmitter of claim 26, where the auxiliary information comprises information associated with a post processing device.

28. A transmitter of claim 26, where the auxiliary information identifies one or more encoding parameters of the data stream.

29. A transmitter of claim 19, where the multiplexer is adapted to form data packets from the data stream for transmission on the communication link.

30. A transmitter of claim 29, where each of the data packets comprises a payload portion for receiving a data portion from the data stream and a header portion for receiving control information from the data stream, where the synchronization information is inserted into the header portion.

31. A transmitter of claim 30, where the communication link comprises a vehicle multimedia bus.

32. A transmitter of claim 31, where the vehicle multimedia bus comprises a Media Oriented Systems Transport (MOST) bus.
